(19) United States
(12) Patent Application Publication
(10) Pub. No.: US 2025/0221430 A1
(43) Pub. Date: Jul. 10, 2025

(54) A newest preparation method (NT-PB) and applications for improving ATP utilization in animal muscle cells

(71) Applicant: Numega Nutrition Pte. Ltd, Singapore (SG)

(72) Inventors: Yafeng Zhai, Singapore (SG); Jaze Francisco Perez Hernandez, Barcelona (ES)

(21) Appl. No.: 18/404,997

(22) Filed: Jan. 5, 2024

(51) Int. Cl. A23K 20/142; A23K 20/174; A23K 20/20

(52) U.S. Cl. CPC A23K 20/142; A23K 20/174; A23K 20/20

(57) ABSTRACT

A preparation method (NT-PB) and application for improving ATP utilization rate of animal muscle cells which includes the following components: guanidinoacetic acid, methionine, betaine, vitamin E, vitamin B12, vitamin B6, folic acid, L-ascorbic acid, L-carnitine, yeast selenium and stearic acid. The method supplements exogenous creatine synthetic raw materials for the animal body, and improves the efficiency of converting guanidinoacetic acid into creatine in the animal body, significantly increases the creatine level in the animal body, and improves the animal body's ability to function at a lower nutritional level (low energy, Under the conditions of low protein), the efficiency of ATP utilization can be reduced, and nutrients converted into energy and consumed, thereby significantly improving animal growth performance and slaughter performance. The raw materials of the invention are all nutritional additives, will not produce residues, are green and safe, meet the urgent needs of the rapid development of antibiotic-free animal husbandry.

### BACKGROUND OF THE INVENTION

### Field of the Invention

The invention belongs to the technical field of feed additives, and specifically relates to a newest preparation method (NT-PB) and application for improving ATP utilization rate of animal muscle cells.

### Description or the Related Art

The energy level in the diet can be roughly divided into three levels: one is insufficient energy, which is the semi-starvation level; second, the energy can only meet maintenance needs, which is the maintenance level; third, the energy level is sufficient, which is the production level. When the energy level is at the semi-starvation level, the energy intake of the animal cannot make ends meet. At this time, in order to maintain life, the animal must first use the reserve glycogen in the body, followed by fat, and then protein. The animal will become increasingly thin and lose weight. If Being in this state for a long time will affect the health and the animal will lose its production capacity. When the energy level is at the maintenance level, the energy consumption of the animal body is exactly equal to the intake. Currently, the animal shows growth stagnation and stable weight. When the energy level is at the production level, it is the energy level of practical significance in animal husbandry production, that is, the energy level correspondingly supplied to exert the different productivity of animals on the premise of meeting the needs of other nutrients. If the energy level is high, it is beneficial to the growth of pregnant female animals in the late embryonic period, promotes the development and sexual maturity of young animals, increases the number of ovulations, promotes fat deposition in fattening animals and secretion of milk in milk-producing animals.

Regardless of the energy level of the diet, in practical applications, since the ability of animal muscle cells to store ATP is very weak, the energy stored at one time can only support 1 to 2 seconds of exercise, so there is inevitably the problem of energy loss, especially for Animal diets with low energy levels urgently need solutions to improve energy utilization so that energy can be utilized to the maximum extent, thereby truly improving animal growth performance.

### SUMMARY OF THE INVENTION

The object of the present invention is to provide a newest preparation method (NT-PB) and application that improves the ATP utilization rate of animal muscle cells in view of the above-mentioned problems existing in the prior art. The feed additive solves the problem of insufficient ATP utilization of animal muscle cells. The problem is that when the energy level of livestock and poultry diets is low, adding this feed additive can effectively improve animal growth performance, muscle deposition and

In order to achieve the above objects of the present invention, the present invention adopts the following technical solutions:

A first aspect of the present invention provides a feed additive that improves ATP utilization in animal muscle cells. The feed additive includes the following raw material components: guanidinoacetic acid, methionine, betaine, vitamin E, vitamin B12, vitamin B6, Folic acid, L-ascorbic acid, L-carnitine, yeast selenium and stearic acid.

Preferably, the feed additive includes the following raw material components in parts by weight: 70-80 parts of guanidinoacetic acid, 1.3-3.45 parts of methionine, 5-9.5 parts of betaine, 0.45-1.2 parts of vitamin E, and 0.32 parts of vitamin B12. −0.5 parts, vitamin B6 0.25-0.5 parts, folic acid 0.36-0.5 parts, L-ascorbic acid 0.56-1.1 parts, L-carnitine 0.5-0.64 parts, yeast selenium 1-1.8 parts, stearic acid 10.06-14.89 parts.

Further preferably, the feed additive includes the following raw material components in parts by weight: 72-75 parts of guanidinoacetic acid, 1.5-2 parts of methionine, 5.2-5.96 parts of betaine, 0.8-1.04 parts of vitamin E, and vitamin B12 0.35-0.45 parts, vitamin B6 0.36-0.44 parts, folic acid 0.45-0.5 parts, L-ascorbic acid 0.8-1.04 parts, L-carnitine 0.51-0.64 parts, yeast selenium 1.02-1.65 parts, stearic acid 11.37-13.04 parts.

The following is a detailed description of the functions of each raw material in the feed additive of the present invention:

(i) Guanidinoacetic acid is the only precursor for creatine synthesis in the body. As a key substance involved in energy metabolism, creatine combines with ATP in muscle cells and is converted into creatine phosphate. Creatine phosphate is the most important energy storage and a key substance in the energy source of muscle cells. When the body needs energy, creatine phosphate transfers energy to ADP to generate ATP, which directly supplies energy for life activities. Studies have shown that adding guanidinoacetic acid to the diet can increase the creatine content in the body, thereby increasing the energy reserves in the animal's body and improving the animal's growth performance and health status. It is especially beneficial to animals in special physiological stages, such as the fattening period. Animals, livestock, and poultry under stress, etc.

(ii) In animals, guanidinoacetic acid must undergo methylation before it can be converted into creatine, but the animal body cannot synthesize methyl groups on its own, and the background methyl groups in the feed can usually only meet the animal's own metabolic needs. Therefore, when additional guanidinoacetic acid is added, a reasonable combination of an appropriate amount of methyl donor is the key to improving the physiological activity of guanidinoacetic acid. The role of methionine and betaine is to provide sufficient methyl donor raw materials for guanidinoacetic acid to make up for the lack of physiological levels of methyl groups and improve the efficiency of converting guanidinoacetic acid into creatine in the body. Guanidinoacetic acid is used in combination with methionine and betaine to synergize, promote animal growth and increase protein deposition in muscles.

(iii) Muscle protein deposition increases, followed by meat quality problems. The present invention improves muscle antioxidant capacity and meat quality by simultaneously compatibility with yeast selenium, vitamin E, L-ascorbic acid, and L-carnitine.

(IV) Homocysteine accumulation is an unavoidable problem when high dose guanidinoacetic acid is added. The present invention simultaneously improves the utilization efficiency of methyl groups by combining vitamin B6, vitamin B12, and folic acid to promote homocysteine. Circulation transformation to avoid damage to the animal body caused by homocysteine accumulation.

(v) In practical applications, the stability of guanidinoacetic acid and methyl donors and their absorption efficiency in the animal intestines must also be considered. Coating with stearic acid can improve their performance in the feed processing process and the animal stomach. Stability in the intestine increases its concentration in the small intestine, thereby achieving the expected application effect.

In yet another aspect of the present invention, a method for preparing the feed additive is provided, which includes the following steps:

(1) Take each raw material and crush it to more than 60 mesh to obtain fine particles of each raw material for later use.

(2) Mix and stir the fine particles of each raw material of vitamin E, vitamin B12, vitamin B6, folic acid, L-ascorbic acid, and L-carnitine evenly, and then mix the evenly mixed raw materials with the remaining fine particles of each raw material and stir evenly to obtain Pellet granule core.

(3) Heat the stearic acid to melt, preferably to above 60° C., and then spray the melted stearic acid evenly onto the surface of the pellet core through an atomizing nozzle to obtain enteric-coated pellets. The granules are the feed additives for improving the ATP utilization rate of animal muscle cells.

Guanidinoacetic acid, methionine, betaine, etc. are easily lost in the front part of the animal's digestive tract, resulting in their inability to reach the middle and rear end of the small intestine and maintain effective concentration. In the present invention, after atomizing stearic acid, they are evenly sprayed on guanidinoacetic acid, methionine, etc., betaine, etc. as the core material, improve the ability of the pellets to withstand acid, alkali and other contents in the front part of the digestive tract, maintain the concentration of active ingredients in the back intestine at a relatively stable high level, thereby increasing the guanidinoacetic acid The efficiency of conversion into creatine improves the utilization rate of ATP by the body's muscle cells.

In another aspect of the present invention, an animal feed is provided, which contains the feed additive. Preferably, the amount of feed additive added to the animal feed is 0.06-0.1%.

In another aspect of the present invention, the application of the feed additive is provided. Specifically, it can be applied to animals including but not limited to pigs, cattle, sheep, chickens, ducks, geese, pigeons, quails, partridges, pheasants, and fish. In feed to improve the ATP utilization rate of animal muscle cells.

The beneficial effects of the present invention are:

The feed additive provided by the invention uses guanidinoacetic acid, methionine, betaine, vitamin E, vitamin B12, vitamin B6, folic acid, L-ascorbic acid, L-carnitine and yeast selenium as main raw materials and is supplemented by a suitable weight formula. The ratio makes the functions of each raw material support each other and synergize with each other. While supplementing the animal body with exogenous creatine synthetic raw materials, it also improves the efficiency of converting guanidinoacetic acid into creatine in the animal body and significantly increases the creatine level in the animal body, improve the animal body's utilization efficiency of ATP under conditions of lower nutritional levels (low energy, low protein), reduce the consumption of nutrients such as protein when converted into energy, and thus significantly improve animal growth performance and slaughter performance. The raw materials of the invention are all nutritional additives, will not produce residues, are green and safe, meet the urgent needs of the rapid development of antibiotic-free animal husbandry, and have broad application prospects.

### DETAILED DESCRIPTION OF THE SEVERAL EMBODIMENTS

To achieve the purpose, technical solutions and advantages of the present invention clearer, the technical solutions of the present invention will be described in detail below. Obviously, the described embodiments are only some of the embodiments of the present invention, but not all the embodiments. Based on the embodiments of the present invention, all other implementations obtained by those of ordinary skill in the art without any creative work fall within the scope of protection of the present invention. Among them, 1 part represents 1 g, and the machine used for mixing is patent number ZL202011515256.8.

### Example 1

A feed additive that improves the ATP utilization rate of animal muscle cells. The raw materials are composed of: 70 parts of guanidinoacetic acid, 3.45 parts of methionine, 5.96 parts of betaine, 0.8 parts of vitamin E, 0.5 parts of vitamin B12, 0.5 parts of vitamin B6, 0.5 parts of folic acid, L-ascorbic acid 1.1 parts, L-carnitine 0.5 parts, yeast selenium 1.8 parts, stearic acid 14.89 parts.

Preparation method: (1) Take each raw material and crush it to 60 mesh respectively to obtain fine particles of each raw material for later use; (2) Combine the raw materials of vitamin E, vitamin B12, vitamin B6, folic acid, L-ascorbic acid, and L-carnitine. The fine particles are mixed and stirred evenly, and then the evenly mixed raw materials are mixed and stirred evenly with the fine particles of the remaining raw materials to obtain pellet cores; (3) Heat the stearic acid to 60° C. to melt, and then the melted hard the fatty acid is evenly sprayed onto the surface of the pellet core through an atomizing nozzle to obtain enteric-coated pellet particles, which are the feed additives for improving the ATP utilization rate of animal muscle cells.

### Example 2

A feed additive that improves ATP utilization in animal muscle cells. The raw materials are composed of: 75 parts of guanidinoacetic acid, 2 parts of methionine, 5.2 parts of betaine, 1.2 parts of vitamin E, 0.35 parts of vitamin B12, 0.25 parts of vitamin B6, 0.5 parts of folic acid, L-ascorbic acid 0.8 parts, L-carnitine 0.64 parts, yeast selenium 1.02 parts, stearic acid 13.04 parts.

Preparation method: (1) Take each raw material and crush it to 80 mesh respectively to obtain fine particles of each raw material for later use; (2) Combine the raw materials of vitamin E, vitamin B12, vitamin B6, folic acid, L-ascorbic acid, and L-carnitine. The fine particles are mixed and stirred evenly, and then the evenly mixed raw materials are mixed and stirred evenly with the fine particles of the remaining raw materials to obtain pellet cores; (3) Heat the stearic acid to 70° C. to melt, and then the melted hard The fatty acid is evenly sprayed onto the surface of the pellet core through an atomizing nozzle to obtain enteric-coated pellet particles, which are the feed additives for improving the ATP utilization rate of animal muscle cells.

### Example 3

A feed additive that improves ATP utilization in animal muscle cells. The raw materials are composed of: 72 parts of guanidinoacetic acid, 1.5 parts of methionine, 9.5 parts of betaine, 1.04 parts of vitamin E, 0.45 parts of vitamin B12, 0.36 parts of vitamin B6, 0.45 parts of folic acid, L-ascorbic acid 1.04 parts, L-carnitine 0.64 parts, yeast selenium 1.65 parts, stearic acid 11.37 parts.

Preparation method: (1) Take each raw material and crush it to 80 mesh respectively to obtain fine particles of each raw material for later use; (2) Combine the raw materials of vitamin E, vitamin B12, vitamin B6, folic acid, L-ascorbic acid, and L-carnitine. The fine particles are mixed and stirred evenly, and then the evenly mixed raw materials are mixed and stirred evenly with the fine particles of the remaining raw materials to obtain pellet cores; (3) Heat the stearic acid to 65° C. to melt, and then melt the melted hard The fatty acid is evenly sprayed onto the surface of the pellet core through an atomizing nozzle to obtain enteric-coated pellet particles, which are the feed additives for improving the ATP utilization rate of animal muscle cells.

### Example 4

A feed additive that improves ATP utilization in animal muscle cells. The raw materials are composed of: 80 parts of guanidinoacetic acid, 1.3 parts of methionine, 5 parts of betaine, 0.45 parts of vitamin E, 0.32 parts of vitamin B12, 0.44 parts of vitamin B6, 0.36 parts of folic acid, L-ascorbic acid 0.56 parts, L-carnitine 0.51 parts, yeast selenium 1 part, stearic acid 10.06 parts.

Preparation method: (1) Take each raw material and crush it to 80 mesh respectively to obtain fine particles of each raw material for later use; (2) Combine the raw materials of vitamin E, vitamin B12, vitamin B6, folic acid, L-ascorbic acid, and L-carnitine. The fine particles are mixed and stirred evenly, and then the evenly mixed raw materials are mixed and stirred evenly with the fine particles of the remaining raw materials to obtain pellet cores; (3) Heat the stearic acid to 65° C. to melt, and then melt the melted hard The fatty acid is evenly sprayed onto the surface of the pellet core through an atomizing nozzle to obtain enteric-coated pellet particles, which are the feed additives for improving the ATP utilization rate of animal muscle cells.

### Test Example 1: Application of the Feed Additive of the Present Invention to Improve the ATP Utilization Rate of Animal Muscle Cells in Broiler Chickens

### Test Raw Materials: Example 1 Feed Additive, Labeled NT-PB¹:

Experimental method: This experiment adopts a two-factor experimental design. A total of 1,600 healthy broiler chickens (ROSS 308) with similar initial weight at 11 days of age were selected and randomly divided into 8 treatment groups, with 4 replicates in each treatment group and 50 chickens in each replicate. Treatment group 1 was fed a corn-soybean meal basal diet, and treatment group 2 added 600 g/t NT-PB¹ on top of the basal diet; The dietary metabolizable energy (ME) levels of treatment groups 3-5 were reduced by 100, 150 and 200 kcal/kg respectively, and 600 g/t NT-PB was added at the same time. Treatment groups 6-8 had dietary metabolizable energy (ME) levels reduced by 100, 150, and 200 kcal/kg, respectively, but did not add NT-PB¹. The specific animal grouping and experimental design are shown in Table 1.

TABLE 1
Experiment 1 Animal Grouping and Experimental Design

| treatments | Animals design | ME(kcal/kg) | NT-PB¹ (g/t) |
|---|---|---|---|
| T1 | 4 × 50 | / | / |
| T2 | 4 × 50 | | +600 |
| T3 | 4 × 50 | −100 | +600 |
| T4 | 4 × 50 | −150 | +600 |
| T5 | 4 × 50 | −200 | +600 |
| T6 | 4 × 50 | −100 | / |
| T7 | 4 × 50 | −150 | / |
| T8 | 4 × 50 | −200 | |

The dietary formula and nutritional levels of each treatment group from 11 to 24 days of age are shown in Table 2.

TABLE 2
Diet formula and nutritional levels of each treatment group from 11 to 24 days old

| Ingredients (%) | T1 | T2 | T3 | T4 | T5 | T6 | T7 | T8 |
|---|---|---|---|---|---|---|---|---|
| Corn | 57.751 | 57.751 | 59.028 | 57.35 | 55.67 | 59.028 | 57.35 | 55.67 |
| Soy oil | 3.584 | 3.584 | 2 | 2 | 2 | 2 | 2 | 2 |
| Soybean meal | 34.42 | 34.42 | 34.188 | 34.428 | 34.768 | 34.188 | 34.428 | 34.768 |
| DL-Methionine | 0.191 | 0.191 | 0.19 | 0.192 | 0.194 | 0.19 | 0.192 | 0.194 |
| L-lysine | 0 | 0 | 0.004 | 0 | 0 | 0.004 | 0 | 0 |
| stone powder | 1.192 | 1.192 | 1.194 | 1.191 | 1.189 | 1.194 | 1.191 | 1.189 |
| Calcium dihydrogen | 1.456 | 1.456 | 1.453 | 1.457 | 1.461 | 1.453 | 1.457 | 1.461 |
| phosphate | | | | | | | | |
| salt | 0.313 | 0.313 | 0.312 | 0.313 | 0.314 | 0.312 | 0.313 | 0.314 |
| Choline chloride | 0.267 | 0.267 | 0.267 | 0.267 | 0.267 | 0.267 | 0.267 | 0.267 |
| vitamin premix | 0.33 | 0.33 | 0.33 | 0.33 | 0.33 | 0.33 | 0.33 | 0.33 |
| Trace element | 0.33 | 0.33 | 0.33 | 0.33 | 0.33 | 0.33 | 0.33 | 0.33 |
| premix | | | | | | | | |
| Antifungal agent | 0.05 | 0.05 | 0.05 | 0.05 | 0.05 | 0.05 | 0.05 | 0.05 |
| Antioxidants | 0.05 | 0.05 | 0.05 | 0.05 | 0.05 | 0.05 | 0.05 | 0.05 |
| Phytase | 0.006 | 0.006 | 0.006 | 0.006 | 0.006 | 0.006 | 0.006 | 0.006 |
| corncob flour | 0.06 | 0 | 0.538 | 1.976 | 3.311 | 0.598 | 2.036 | 3.371 |
| NT-PB¹ | 0 | 0.06 | 0.06 | 0.06 | 0.06 | 0 | 0 | 0 |
| Total | 100 | 100 | 100 | 100 | 100 | 100 | 100 | 100 |

nutritional level

| | | | | | | | | |
|---|---|---|---|---|---|---|---|---|
| Poultry ME | 3100 | 3100 | 3000 | 2950 | 2900 | 3000 | 2950 | 2900 |
| (Kcal/Kg) | | | (−100) | (−150) | (−200) | (−100) | (−150) | (−200) |
| CP (%) | 21.5 | 21.5 | 21.5 | 21.5 | 21.5 | 21.5 | 21.5 | 21.5 |

The dietary formula and nutritional levels of each treatment group at 25-35 days of age are shown in Table 3.

TABLE 3
Diet formula and nutritional levels of each treatment group at 25-35 days of age

| Ingredients ( %) | T1 | T2 | T3 | T4 | T5 | T6 | T7 | T8 |
|---|---|---|---|---|---|---|---|---|
| Corn | 61.272 | 61.272 | 63.582 | 62.67 | 60.992 | 63.582 | 62.67 | 60.992 |
| Soy oil | 5.194 | 5.194 | 3.26 | 3 | 3 | 3.26 | 3 | 3 |
| Soybean meal | 29.632 | 29.632 | 29.214 | 29.376 | 29.675 | 29.214 | 29.376 | 29.675 |
| DL-Methionine | 0.174 | 0.174 | 0.171 | 0.172 | 0.174 | 0.171 | 0.172 | 0.174 |
| L-lysine | 0.013 | 0.013 | 0.022 | 0.019 | 0.013 | 0.022 | 0.019 | 0.013 |
| stone powder | 1.099 | 1.099 | 1.103 | 1.101 | 1.099 | 1.103 | 1.101 | 1.099 |
| Calcium dihydrogen | 1.263 | 1.263 | 1.258 | 1.26 | 1.264 | 1.258 | 1.26 | 1.264 |
| phosphate | | | | | | | | |
| salt | 0.317 | 0.317 | 0.315 | 0.316 | 0.317 | 0.315 | 0.316 | 0.317 |
| Choline chloride | 0.25 | 0.25 | 0.25 | 0.25 | 0.25 | 0.25 | 0.25 | 0.25 |
| vitamin premix | 0.33 | 0.33 | 0.33 | 0.33 | 0.33 | 0.33 | 0.33 | 0.33 |
| Trace element | 0.33 | 0.33 | 0.33 | 0.33 | 0.33 | 0.33 | 0.33 | 0.33 |
| premix | | | | | | | | |
| Antifungal agent | 0.05 | 0.05 | 0.05 | 0.05 | 0.05 | 0.05 | 0.05 | 0.05 |
| Antioxidants | 0.01 | 0.01 | 0.01 | 0.01 | 0.01 | 0.01 | 0.01 | 0.01 |
| Phytase | 0.006 | 0.006 | 0.006 | 0.006 | 0.006 | 0.006 | 0.006 | 0.006 |
| corncob flour | 0.06 | 0 | 0.039 | 1.05 | 2.43 | 0.099 | 1.11 | 2.49 |
| NT-PB¹ | 0 | 0.06 | 0.06 | 0.06 | 0.06 | 0 | 0 | 0 |
| Total | 100 | 100 | 100 | 100 | 100 | 100 | 100 | 100 |

nutritional level

| | | | | | | | | |
|---|---|---|---|---|---|---|---|---|
| Poultry ME | 3250 | 3250 | 3150 | 3100 | 3050 | 3150 | 3100 | 3050 |
| (Kcal/Kg) | | | (−100) | (−150) | (−200) | (−100) | (−150) | (−200) |
| CP (%) | 19.5 | 19.5 | 19.5 | 19.5 | 19.5 | 19.5 | 19.5 | 19.5 |

The experiment lasted for 25 days. During the experiment, the chickens had free access to food and water. All chickens are raised according to routine feeding and management. The feed intake, feces and mental status of the chickens are observed daily, and sick chickens are recorded and dealt with in a timely manner.

At the beginning and end of the test, the chickens were weighed on an empty stomach in terms of weight, and the average daily weight gain, average daily feed intake and feed consumption to weight gain ratio of the chickens during the entire test period were calculated. On the 35th day of the experiment, one chicken from each replicate was randomly selected for the slaughter experiment. The effects of different dietary treatments on the growth performance and slaughter performance of broilers aged 11-35 days are show in table 4.

TABLE 4
Growth performance and slaughter performance of broiler chickens in different dietary treatment groups

| | | | | | | | P value | | | |
|---|---|---|---|---|---|---|---|---|---|---|
| | | | | | | | | | | interaction |
| | NT-PB¹ | | | | | | | | | effect |
| | dose | Poultry ME reduction (Kcal/Kg) | | | | | | NT-PB¹ | ME | NT-PB¹ × |
| Items | (g/t) | 0 | 100 | 150 | 200 | AVG | total | dose | reduction | ME |
| ADG(g) | 0 | 81.40 ± 1.46 | 82.22 ± 1.48 | 78.52 ± 0.61 | 80.71 ± 1.74 | 80.71^{B} | 0.12 | 0.04 | 0.11 | 0.75 |
| | 600 | 82.79 ± 4.38 | 82.68 ± 1.37 | 81.32 ± 2.62 | 82.44 ± 0.85 | 82.31^{A} | | | | |
| | AVG | 82.09 | 82.45 | 79.92 | 81.57 | | | | | |
| ADFI(g) | 0 | 117.58 ± 2.47 | 121.34 ± 5.05 | 120.52 ± 4.38 | 119.65 ± 2.06 | 119.77 | 0.8 | 0.83 | 0.35 | 0.97 |
| | 600 | 117.89 ± 7.29 | 121.49 ± 1.82 | 119.06 ± 2.74 | 119.43 ± 2.99 | 119.47 | | | | |
| | AVG | 117.73 | 121.41 | 119.79 | 119.54 | | | | | |
| FCR | 0 | 1.45 ± 0.02 | 1.48 ± 0.06 | 1.54 ± 0.05 | 1.49 ± 0.02 | 1.49^{A} | 0.03 | 0.02 | 0.03 | 0.45 |
| | 600 | 1.43 ± 0.02 | 1.47 ± 0.03 | 1.47 ± 0.06 | 1.45 ± 0.04 | 1.45^{B} | | | | |
| | AVG | 1.44^{b} | 1.48^{ab} | 1.51^{a} | 1.48^{ab} | | | | | |
| Mortality | 0 | 0.00 ± 0.00 | 0.50 ± 1.00 | 0.00 ± 0.00 | 0.00 ± 0.00 | 0.13 | 0.66 | 0.57 | 0.32 | 0.8 |
| rate (%) | 600 | 0.00 ± 0.00 | 0.50 ± 1.00 | 0.00 ± 0.00 | 0.50 ± 1.00 | 0.25 | | | | |
| | AVG | 0 | 0.5 | 0 | 0.25 | | | | | |
| Slaughter | 0 | 81.15 ± 1.66 | 81.98 ± 1.56 | 81.75 ± 1.14 | 81.60 ± 1.51 | 81.62 | 0.65 | 0.1 | 0.79 | 0.73 |
| rate (%) | 600 | 81.24 ± 2.99 | 81.23 ± 1.59 | 80.75 ± 1.46 | 80.38 ± 1.29 | 80.9 | | | | |
| | AVG | 81.19 | 81.6 | 81.25 | 80.99 | | | | | |
| Brest | 0 | 18.12 ± 1.54 | 18.24 ± 1.70 | 18.81 ± 1.08 | 18.39 ± 0.74 | 18.39^{B} | 0.07 | 0.006 | 0.36 | 0.44 |
| yield (%) | 600 | 18.63 ± 1.37 | 20.02 ± 1.22 | 19.26 ± 0.99 | 19.32 ± 1.37 | 19.31^{A} | | | | |
| | AVG | 18.38 | 19.13 | 19.03 | 18.85 | | | | | |
| abdominal fat | 0 | 1.50 ± 0.29 | 1.53 ± 0.35 | 1.44 ± 0.29 | 1.42 ± 0.20 | 1.47^{A} | 0.01 | 0.02 | 0.02 | 0.56 |
| yield (%) | 600 | 1.23 ± 0.32 | 1.46 ± 0.37 | 1.10 ± 0.24 | 1.02 ± 0.21 | 1.20^{B} | | | | |
| | AVG | 1.37^{ab} | 1.5^{a} | 1.27^{b} | 1.22^{b} | | | | | |

Note:
^{a, b}represent the average values in the same row with different letters on the shoulder, and the difference is statistically significant (p < 0.05);
^{A, B}represent the average values in the same column with different letters, and the difference is statistically significant (p< 0.05)

As can be seen from Table 4, considering the main effect of NT-PB addition amount alone, adding 600 g/t NT-PB¹ significantly increased the average daily weight gain and breast muscle rate of broilers aged 11-35 days (p<0.05), and significantly reduced the weight gain of broiler chickens. Feed-to-meat ratio and abdominal fat rate (p<0.05). When the ME level was reduced by 100, 150 and 200 Kcal/kg respectively, the average daily weight gain and breast muscle rate, feed-to-meat ratio and abdominal fat rate of broiler chickens in the 600 g/t NT-PB¹ group were higher than those in the 0 g/t NT-PB¹ group. All are lower than the 0 g/t NT-PB¹ group. The results suggest that when reducing the ME level of broiler diets to 0-200 kcal/kg, adding 600 g/t NT-PB¹ can significantly promote the growth of broiler chickens, increase muscle protein deposition, and reduce abdominal fat deposition. This shows that adding NT-PB¹ can improve broiler chicken growth. The body's utilization efficiency of ATP enables broiler chickens to still achieve better growth and muscle development under a lower level of energy supply.

### Test Example 2: Application of the Feed Additive of the Present Invention to Improve the ATP Utilization Rate of Animal Muscle Cells in Pigs

### Test Raw Materials: Example 3 Feed Additive, Labeled NT-PB³:

Experimental method: This experiment adopts a two-factor experimental design. A total of 90 Dux long large pigs with good health and close initial weight (approximately 50 kg) were selected and randomly divided into 5 treatment groups, with 6 replicates in each treatment group and 3 pigs in each replicate. Treatment group 1 was fed a basal diet, treatment group 2 was fed a basal diet with crude protein (CP) and digestible energy (DE) levels reduced by 1% and 50 kcal/kg respectively, and treatment group 3 was fed a basal diet. Above, the dietary crude protein level and digestible energy level were reduced by 1.5% and 100 kcal/kg respectively. Treatment groups 4 and 5 added 1 kg/t NT-PB3 to the diets of treatment groups 2 and 3 respectively. The specific animal grouping and experimental design are shown in Table 5.

TABLE 5
Experiment 2 animal grouping and experimental design

| Treatments | Animal design | CP (%) | DE(kcal/kg) | NT-PB³ (kg/t) |
|---|---|---|---|---|
| T1 | 6 × 3 | / | / | / |
| T2 | 6 × 3 | −1 | −50 | / |
| T3 | 6 × 3 | −1.5 | −100 | / |
| T4 | 6 × 3 | −1 | −50 | +1 |
| T5 | 6 × 3 | −1.5 | −100 | +1 |

The dietary nutritional levels of pigs in different treatment groups are shown in Table 6 and table 7.

TABLE 6
Diet formula and nutritional level of
each treatment group (50-78 kg pigs)

| Ingredients (%) | T1 | T2 | T3 | T4 | T5 |
|---|---|---|---|---|---|
| Corn | 22.6 | 19.64 | 15.27 | 19.64 | 15.27 |
| Cassava | 40 | 40 | 40 | 40 | 40 |
| Tapioca flour | 6 | 11 | 16 | 10.9 | 15.9 |
| Rice bran oil | 1.55 | 1.56 | 1.6 | 1.56 | 1.6 |
| Soybean meal | 26.97 | 24.76 | 24.04 | 24.76 | 24.04 |
| 46% | | | | | |
| DL-Methionine | 0.21 | 0.24 | 0.26 | 0.24 | 0.26 |
| L-lysine | 0.34 | 0.42 | 0.45 | 0.42 | 0.45 |
| L-threonine | 0.1 | 0.14 | 0.17 | 0.14 | 0.17 |
| stone powder | 0.45 | 0.42 | 0.37 | 0.42 | 0.37 |
| Calcium | 1.09 | 1.13 | 1.15 | 1.13 | 1.15 |
| dihydrogen | | | | | |
| phosphate | | | | | |
| salt | 0.35 | 0.35 | 0.35 | 0.35 | 0.35 |
| Choline chloride | 0.03 | 0.03 | 0.03 | 0.03 | 0.03 |
| Pig premix | 0.3 | 0.3 | 0.3 | 0.3 | 0.3 |
| Phytase | 0.01 | 0.01 | 0.01 | 0.01 | 0.01 |
| NT-PB³ | 0 | 0 | 0 | 0.1 | 0.1 |
| Total | 100 | 100 | 100 | 100 | 100 |

Nutritional level

| | | | | | |
|---|---|---|---|---|---|
| DE(Kcal/Kg) | 3200 | 3150(−50) | 3100 | 3150 | 3100 |
| | | | (−100) | (−50) | (−100) |
| CP(%) | 16 | 15(−1) | 14.5(−1.5) | 15(−1) | 14.5(−1.5) |

TABLE 7
Diet formula and nutritional levels of
each treatment group (78-110 kg pigs)

| ingredients (%) | T1 | T2 | T3 | T4 | T5 |
|---|---|---|---|---|---|
| Corn | 24.43 | 21.5 | 17.45 | 21.5 | 17.45 |
| Cassava | 40 | 40 | 40 | 40 | 40 |
| Tapioca flour | 4.99 | 9.97 | 14.73 | 9.87 | 14.63 |
| Rice bran oil | 2 | 2 | 2 | 2 | 2 |
| Soybean meal | 24.29 | 22.08 | 21.31 | 22.08 | 21.31 |
| 46% | | | | | |
| DL-Methionine | 0.27 | 0.3 | 0.32 | 0.3 | 0.32 |
| L-lysine | 0.36 | 0.44 | 0.47 | 0.44 | 0.47 |
| L-threonine | 0.17 | 0.22 | 0.24 | 0.22 | 0.24 |
| stone powder | 1.25 | 1.22 | 1.18 | 1.22 | 1.18 |
| Calcium | 1.56 | 1.59 | 1.62 | 1.59 | 1.62 |
| dihydrogen | | | | | |
| phosphate | | | | | |
| salt | 0.34 | 0.34 | 0.34 | 0.34 | 0.34 |
| Choline chloride | 0.03 | 0.03 | 0.03 | 0.03 | 0.03 |
| Pig premix | 0.3 | 0.3 | 0.3 | 0.3 | 0.3 |
| Phytase | 0.01 | 0.01 | 0.01 | 0.01 | 0.01 |
| NT-PB³ | 0 | 0 | 0 | 0.1 | 0.1 |
| Total | 100 | 100 | 100 | 100 | 100 |

Nutritional level

| | | | | | |
|---|---|---|---|---|---|
| DE(Kcal/Kg) | 3200 | 3150(−50) | 3100 | 3150 | 3100 |
| | | | (−100) | (−50) | (−100) |
| CP(%) | 15 | 14(−1) | 13.5(−1.5) | 14(−1) | 13.5(−1.5) |

The trial period is 13 weeks. During the experiment, food and water were available ad libitum. All pigs are raised according to routine feeding and management, and their feed intake, feces and mental status are observed daily, and sick pigs are recorded and dealt with in a timely manner.

At the beginning and end of the test, the pigs were weighed on an empty stomach in terms of weight, and the average daily weight gain, average daily feed intake and feed-to-weight gain ratio of the pigs during the entire test period were calculated. At the end of the experiment, one pig was randomly selected from each replicate for slaughtering experiments for meat quality and blood creatine and homocysteine content testing. The effects of different dietary treatments on pig growth performance, slaughter performance and blood creatine and homocysteine contents of pigs in different treatment groups.

TABLE 8
Growth performance, slaughter performance and blood creatine and
homocysteine contents of pigs in different treatment groups

| Parameters | T1 | T2 | T3 | T4 | T5 |
|---|---|---|---|---|---|
| Initial Bw (kg) | 51.69 ± 1.33 | 51.63 ± 1.08 | 51.78 ± 1.27 | 51.73 ± 1.07 | 51.74 ± 1.33 |
| Final Bw (kg) | 106.94 ± 2.18^{c} | 104.31 ± 1.69^{ab} | 102.82 ± 1.86^{a} | 106.83 ± 1.90^{c} | 106.26 ± 1.70^{bc} |
| ADG (kg) | 0.61 ± 0.01^{c} | 0.58 ± 0.01^{b} | 0.56 ± 0.01^{a} | 0.61 ± 0.02^{c} | 0.6 ± 0.01^{c} |
| ADFI (kg) | 2.16 ± 0.01 | 2.16 ± 0.01 | 2.16 ± 0.01 | 2.16 ± 0.01 | 2.17 ± 0.01 |
| FCR | 3.56 ± 0.09^{a} | 3.74 ± 0.07^{b} | 3.85 ± 0.04^{c} | 3.57 ± 0.08^{a} | 3.63 ± 0.08^{a} |
| Blood Creatine (mg/dL) | 1.66 ± 0.13^{a} | 1.64 ± 0.13^{a} | 1.71 ± 0.06^{a} | 1.90 ± 0.09^{b} | 1.85 ± 0.08^{b} |
| Serum homocysteine (umol/L) | 14.03 ± 1.17 | 14.16 ± 1.04 | 14.92 ± 1.53 | 15.08 ± 1.57 | 15.72 ± 1.86 |
| Backfat thickness (mm) | 21.51 ± 0.18^{a} | 21.08 ± 0.25^{b} | 20.68 ± 0.18^{c} | 21.32 ± 0.13^{ab} | 21.17 ± 0.22^{b} |
| Eye muscle area (cm²) | 75.21 ± 0.88^{c} | 69.06 ± 1.62b | 62.80 ± 1.84^{a} | 74.76 ± 1.41^{c} | 73.55 ± 2.21^{c} |

Note:
^{a},^{b},^{c}represent different letters in the same row of shoulder marks, and the difference is statistically significant (p < 0.05).

As can be seen from Table 8, compared with the control group (T1 group), the final weight, average daily weight gain, backfat thickness and eye muscle area of the T2 and T3 groups were significantly reduced, and the feed-to-meat ratio was significantly increased, and the T2 and T3 groups were There was a significant difference between the two groups in the T3 group. It can be seen that reducing the dietary digestible energy and crude protein levels significantly reduced the growth performance and muscle deposition of pigs and was positively correlated with the reduction in digestible energy and crude protein. The diets of the T4 and T5 groups were added with 1 kg/t NT-PB³ on the basis of the diets of the T2 and T3 groups respectively. The results showed that the average daily weight gain, feed-to-meat ratio, backfat thickness and eye muscle of the pigs were significantly lower than those of the T2 and T3 groups. The area was significantly improved, and the creatine content in the blood was significantly increased, but the homocysteine concentration in the serum was not significantly changed. This shows that when reducing dietary energy and protein levels, adding NT-PB³ can increase blood creatine content, thereby increasing the utilization rate of ATP by muscle cells, reducing the conversion of nutrients such as protein into energy and being consumed, thereby promoting muscle deposition. The growth performance and slaughter performance of animals are improved, and there is no significant increase in serum homocysteine content, which avoids the damage to the animal body caused by the accumulation of homocysteine.

Based on the above test conclusions, the feed additive provided by the present invention can improve the utilization efficiency of ATP by the animal body, promote animal growth, and improve muscle deposition.

The above are only specific embodiments of the present invention, but the protection scope of the present invention is not limited thereto. Any person familiar with the technical field can easily think of changes or substitutions within the technical scope disclosed in the present invention. should be covered by the protection scope of the present invention. Therefore, the protection scope of the present invention should be subject to the protection scope of the claims.

What is claimed is:

1. A feed additive that improves ATP utilization in animal muscle cells, characterized in that the feed additive includes the following raw material components comprising:
Guanidinoacetic acid, methionine, betaine, vitamin E, vitamin B12, vitamin B6, folic acid, L-ascorbic acid, L-carnitine, yeast selenium and stearic acid.

2. The feed additive for improving the ATP utilization rate of animal muscle cells according to claim 1, characterized in that, in parts by weight, the feed additive includes the following raw material components:
Guanidinoacetic acid 70-80 parts, methionine 1.3-3.45 parts, betaine 5-9.5 parts, vitamin E 0.45-1.2 parts, vitamin B12 0.32-0.5 parts, vitamin B6 0.25-0.5 parts, folic acid 0.36-0.5 parts, L-Ascorbic acid 0.56-1.1 parts, L-carnitine 0.5-0.64 parts, yeast selenium 1-1.8 parts, stearic acid 10.06-14.89 parts.

3. The feed additive for improving ATP utilization of animal muscle cells according to claim 1, characterized in that, in parts by weight, the feed additive includes the following raw material components:
Guanidinoacetic acid 72-75 parts, methionine 1.5-2 parts, betaine 5.2-5.96 parts, vitamin E 0.8-1.04 parts, vitamin B12 0.35-0.45 parts, vitamin B6 0.36-0.44 parts, folic acid 0.45-0.5 parts, L-Ascorbic acid 0.8-1.04 parts, L-carnitine 0.51-0.64 parts, yeast selenium 1.02-1.65 parts, stearic acid 11.37-13.04 parts.

4. A method for preparing a feed additive for improving ATP utilization in animal muscle cells according to claim 1, comprising the steps of:
(1) Take each raw material and crush it to more than 60 mesh to obtain fine particles of each raw material for later use.
(2) Mix and stir the fine particles of each raw material of vitamin E, vitamin B12, vitamin B6, folic acid, L-ascorbic acid, and L-carnitine evenly, and then mix the evenly mixed raw materials with the remaining fine particles of each raw material and stir evenly to obtain Pellet granule core.
(3) Heat the stearic acid to melt it, and then spray the melted stearic acid evenly onto the surface of the pellet core through an atomizing nozzle to obtain enteric-coated pellet particles, which are the improved animal products. Feed additive for muscle cell ATP utilization.

5. The method for preparing a feed additive for improving ATP utilization in animal muscle cells according to claim 4, characterized in that in step (3), the heating is above 60° C.

6. An animal feed, characterized in that the animal feed contains the feed additive according to claim 1.

7. The animal feed according to claim 6, characterized in that, in the animal feed, the added amount of feed additive is 0.06-0.1%.

8. Application of the feed additive according to claim 1 in animal feed to improve ATP utilization of animal muscle cells.
